(19) United States
(12) Patent Application Publication
(10) Pub. No.: US 2003/0094554 A1
(43) Pub. Date: May 22, 2003

(54) Caster mounting bracket

(76) Inventor: Richard D. Bushey, Kenosha, WI (US)

Correspondence Address: PETER C. STOMMA, Suite 1030, 250 E. Wisconsin Avenue, Milwaukee, WI, 53202, US

(21) Appl. No.: 10/271,716

(22) Filed: Oct. 16, 2002

Related U.S. Application Data
(60) Provisional application No. 60/329,833, filed on Oct. 16, 2001.

(51) Int. Cl. A47K 1/00; F16L 3/08

(52) U.S. Cl. 248/223.41; 248/346.11

(57) ABSTRACT

A bracket is provided for interconnecting a caster plate of a wheeled caster to a bottom surface of an object. The bracket includes a mounting plate that extends along an axis. A first guide track extends along the lower surface of the mounting plate adjacent the first side of the mounting plate. The first guide track has an upper surface for receiving the caster plate thereon, and first and second open ends. A second guide track extends along the lower surface of the mounting plate adjacent the second side of the mounting plate. The second guide track has an upper surface for receiving the caster plate thereon, and first and second open ends. It is contemplated for the caster plate to be slidably positioned on the upper surfaces of the first and second guide tracks from either the first ends of the first and second guide tracks or the second ends of the first and second guide tracks.

### CROSS-REFERENCE TO RELATED APPLICATIONS

This application claims the benefit of U.S. Provisional Application Serial No. 60/329,833, filed Oct. 16, 2001.

### FIELD OF THE INVENTION

This invention relates generally to a mounting structure for mounting caster wheels to an object, and in particular, to a caster mounting bracket for removably connecting a caster wheel to an article of furniture or the like.

### BACKGROUND AND SUMMARY OF THE INVENTION

As is known, caster wheels are often interconnected to various items such as furniture, file cabinets, luggage and the like. While these items are often manufactured with the caster wheels already mounted thereon, the mounting of the caster wheels on an object during the manufacture thereof presents certain unique problems. For example, in order to safely ship an object after caster wheels have been attached thereto, specialized packaging must be used in order to prevent the caster wheels from being knocked off the article during shipment. This, in turn, increases the overall expense of the article.

In view of the foregoing, mounting brackets have been developed to allow for the caster wheels to be attached and/or removed from the article after the manufacture thereof. By way of example, Murphy, U.S. Pat. No. 4,817,237 discloses a retention bracket for interconnecting the caster plate of a wheeled caster to an object such as luggage or an article of furniture. The bracket defines a mounting plate or base plate having two elongated guides or holders that are laterally spaced apart at opposite sides of the plate. The bracket has an inner, laterally elongated stop which projects from the plate and an elongated, cantilevered retention arm having an abutment at the free end thereof. In operation, the caster plate may be axially slid over the abutment of the retention arm such that the retention arm is biased below the surface of the plate. The caster plate slides along the upper surface of the plate of the bracket, but until such point that the leading end of the caster plate engages the stop and the trailing end of the caster plate passes the abutment so as to allow the retention arm, and hence the abutment, to return to its original position thereby capturing the caster plate between the stop and the abutment of the retention arm. Guides prevent lateral movement of the caster plate when the caster plate is positioned between the stop and the abutment on the retention arm.

Although functional for its intended purpose, the retention bracket disclosed in the Murphy '237 patent has significant limitations. It is noted that the retention bracket disclosed in the Murphy '237 patent is designed for a caster plate having a predetermined width and length. Any variance in the width or length of the caster plate will cause movement of the caster plate within the retention bracket and increase the likelihood that the retention bracket for the caster plate would fail. Further, the caster plate may be inserted into the retention bracket only from a single end thereof. As a result, when a retention bracket is mounted on the article, care must be taken to insure that the retention bracket is mounted in such a position and in such a manner as to allow the caster plate to be inserted into the retention bracket, since the improper mounting of the retention bracket may prevent the caster plate from being axially slid therein. Finally, due to the structure of the guide tracks, the retention bracket disclosed in the Murphy '237 patent may only accommodate a caster plate having a generally rectangular configuration. Caster plates having circular configurations cannot be snuggly retained within the retention bracket.

Therefore, it is a primary object and feature of the present invention to provide a caster mounting bracket for interconnecting a caster wheel to an object that is simple and inexpensive to manufacture.

It is a still further object and feature of the present invention to provide a caster mounting bracket for interconnecting a caster wheel to an object that accommodates different configurations of caster plate for the caster wheel.

It is a still further object and feature of the present invention to provide a caster mounting bracket for interconnecting a caster wheel to an object that allows for the caster plate of the caster wheel to be inserted within the caster mounting bracket from either end thereof.

In accordance with the present invention, a bracket is provided for interconnecting a caster plate of a wheeled caster to a bottom surface of a furniture article. The bracket includes a generally flat mounting plate extending along an axis. The mounting plate has upper and lower surfaces, first and second sides and first and second ends. First and second parallel guide tracks extending along the lower surface of the mounting plate. Each guide track has an upper surface for receiving the caster plate thereon, and first and second open ends. First and second plate retaining elements project from the lower surface of the mounting plate for retaining the caster plate on the upper surfaces of the guide tracks and for preventing axial movement of the caster plate.

The first ends of the first and second guide tracks define an opening therebetween for allowing the caster plate to be slidably positioned on the upper surfaces of the first and second guide tracks. Similarly, the second ends of the first and second guide tracks define a second opening therebetween for allowing the caster plate to be slidably positioned on the upper surfaces of the first and second guide tracks. The upper surfaces of the first and second guide tracks include first and second portions axially spaced portions defining caster receiving gaps therebetween.

The first retaining element includes a first resilient tab projecting from the lower surface of the mounting plate and the second retaining element includes a second resilient tab projecting from the lower surface of the mounting plate at a location axially spaced from the first resilient tab. Alternatively, the first retaining element includes a generally rigid projection projecting from the lower surface of the mounting plate and the second retaining element includes a generally rigid projection projecting from the lower surface of the mounting plate at a location axially spaced from the generally rigid projection of the first retaining element.

The first and second guide tracks include generally vertical sidewalls for interconnecting the upper surfaces of the guide tracks and the lower surface of the mounting plate. A mounting structure is provided for operatively connecting the mounting plate to the furniture article.

In accordance with a further aspect of the present invention, a bracket is provided for interconnecting a caster plate of a wheeled caster to a bottom surface of a furniture article. The bracket includes a mounting plate that extends along an axis. The mounting plate has upper and lower surfaces, first and second sides and first and second ends. A first guide track extends along the lower surface of the mounting plate adjacent the first side of the mounting plate. The first guide track has an upper surface for receiving the caster plate thereon, and first and second open ends. A second guide track extends along the lower surface of the mounting plate adjacent the second side of the mounting plate. The second guide track has an upper surface for receiving the caster plate thereon, and first and second open ends. It is contemplated for the caster plate to be slidably positioned on the upper surfaces of the first and second guide tracks from either one of the first ends of the first and second guide tracks or the second ends of the first and second guide tracks.

The first ends of the first and second guide tracks define an opening therebetween for allowing the caster plate to be slidably positioned on the upper surfaces of the first and second guide tracks. Similarly, the second ends of the first and second guide tracks define a second opening therebetween for allowing the caster plate to be slidably positioned on the upper surfaces of the first and second guide tracks. The upper surfaces of the first and second guide tracks include first and second portions axially spaced portions defining caster receiving gaps therebetween.

It is contemplated that a first resilient tab project from the lower surface of the mounting plate and a second resilient tab project from the lower surface of the mounting plate at a location axially spaced from the first resilient tab. Alternatively, a first, generally rigid projection may project from the lower surface of the mounting plate and a second, generally rigid projection may project from the lower surface of the mounting plate at a location axially spaced from the first, generally rigid projection.

The first and second guide tracks include generally vertical sidewalls for interconnecting the upper surfaces of the guide tracks and the lower surface of the mounting plate. A mounting structure is provided for operatively connecting the mounting plate to the furniture article.

In accordance with a still further aspect of the present invention, a bracket is provided for interconnecting a caster plate of a wheeled caster to a bottom surface of a furniture article. The bracket includes a mounting plate extending along an axis and having upper and lower surfaces, first and second sides and first and second ends. A first guide track extends along the lower surface of the mounting plate adjacent the first side of the mounting plate. The first guide track has first and second axially spaced support surfaces for supporting the caster plate thereon. A second guide track extends along the lower surface of the mounting plate adjacent the second side of the mounting plate. The second guide track has first and second axially spaced support surfaces for supporting the caster plate thereon.

The first guide track has first and second open ends and the second guide track has first and second open ends. As such, the first ends of the first and second guide tracks define an opening therebetween for allowing the caster plate to be slidably positioned on the supporting surfaces of the first and second guide tracks. Similarly, the second ends of the first and second guide tracks define a second opening therebetween for allowing the caster plate to be slidably positioned on the supporting surfaces of the first and second guide tracks.

It is contemplated that a first resilient tab project from the lower surface of the mounting plate and a second resilient tab project from the lower surface of the mounting plate at a location axially spaced from the first resilient tab. Alternatively, a first, generally rigid projection may project from the lower surface of the mounting plate and a second, generally rigid projection may project from the lower surface of the mounting plate at a location axially spaced from the first, generally rigid projection. The first and second guide tracks include generally vertical sidewalls for interconnecting the upper surfaces of the guide tracks and the lower surface of the mounting plate. A mounting structure is provided for operatively connecting the mounting plate to the furniture article.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is a side elevational view of a caster mount system in accordance with the present invention interconnecting a caster to an object;

FIG. 2 is an isometric view of a mounting plate for the caster mount system of the present invention;

FIG. 3 is a cross-sectional view taken along line 3-3 of FIG. 2;

FIG. 4 is a cross-sectional view taken along line 4-4 of FIG. 2;

FIG. 5 is a cross-sectional view taken along line 5-5 of FIG. 2;

FIG. 6 is a cross-sectional view, similar to FIG. 3, showing an alternate embodiment of the mounting plate for the caster system of the present invention;

FIG. 7 is a cross-sectional view taken along line 7-7 of FIG. 6;

FIG. 8 is a cross-sectional view, similar to FIG. 7, showing an alternate embodiment of the mounting plate for the caster mounting system of the present invention;

FIG. 9 is a cross-sectional view, similar to FIG. 8, showing a still further embodiment of the mounting plate for the caster mounting system of the present invention;

FIG. 10 is an isometric view of a second embodiment of the caster mounting system of the present invention;

FIG. 11 is an end view of the caster mounting system of FIG. 10 showing a caster mounted to an object.

### DETAILED DESCRIPTION OF THE DRAWINGS

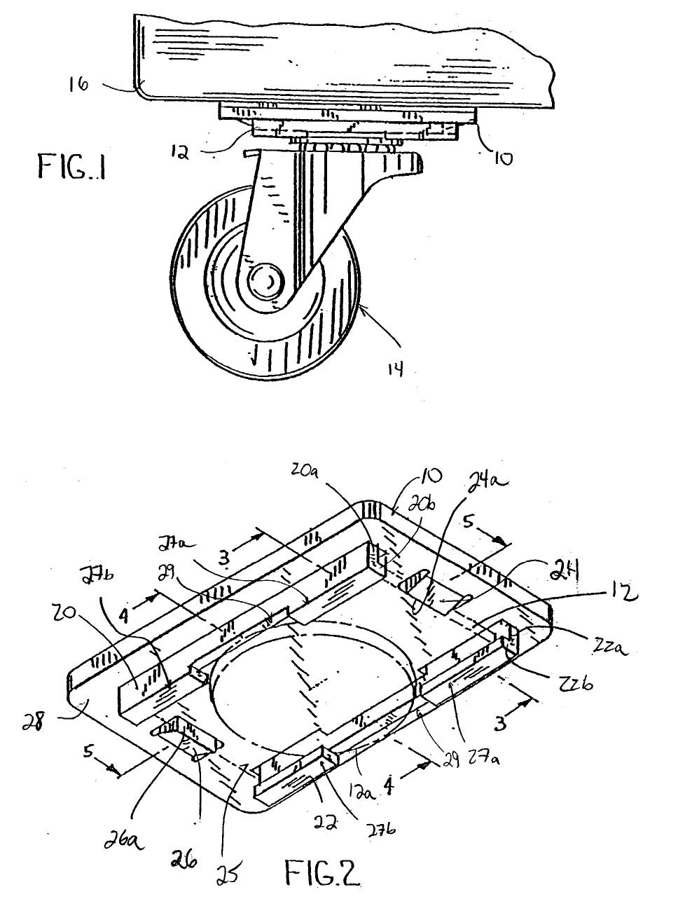

Referring to FIGS. 1 and 2, a mounting bracket in accordance with the present invention is generally designated by the reference numeral 10. It is intended that mounting bracket 10 interconnect caster plate 12 of conventional caster wheel assembly 14 to an object 16 such as furniture, luggage, file cabinets or the like. Mounting bracket 10 may be affixed directly to object 16 or may be integrally formed with mounting assembly 18, FIGS. 10-11, as hereinafter described, that, in turn, is affixed to object 16. For example, mounting bracket 10 may be affixed to object 16 using an adhesive, a fastening element such as a screw or the like, or in other manners customary in the trade.

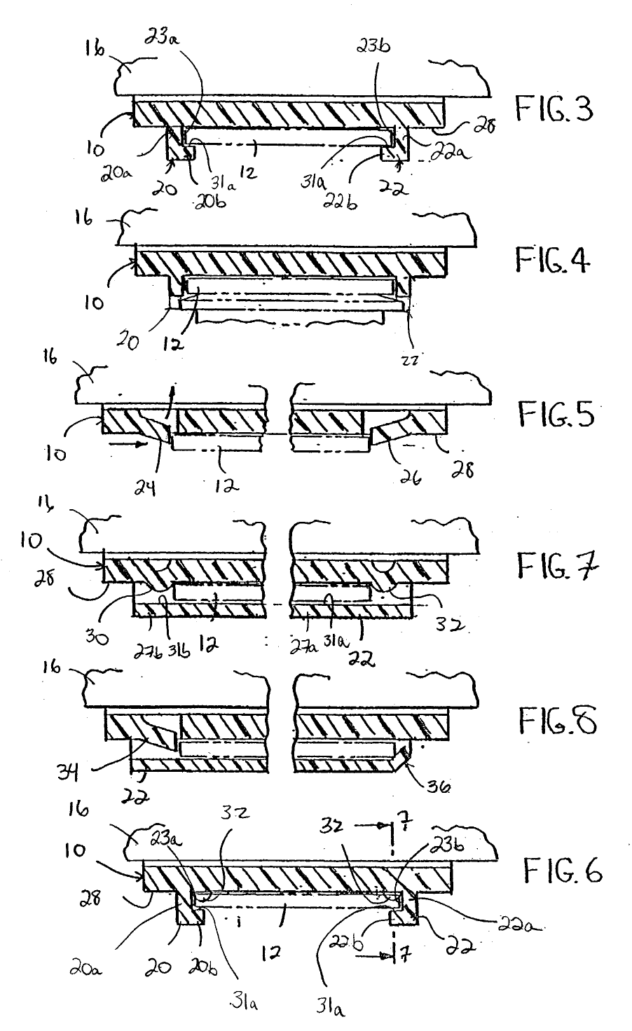

Mounting bracket 10 has two longitudinally extended guides 20 and 22 that are laterally spaced to accommodate opposite sides of caster plate 12 therebetween, FIGS. 3-4. Guides 20 and 22 include vertical sidewalls 20a and 22a, respectively, that depend from lower surface 28 of mounting bracket 10 and horizontal sidewalls 20b and 22b, respectively, the extend from the terminal ends of corresponding vertical sidewalls 20a and 22a. Vertical sidewalls 20a and 22a include opposed vertical surfaces 23a and 23b, respectively, that define caster plate receiving void 25 therebetween. Vertical surfaces 23a and 23b of vertical sidewalls 20a and 22a, respectively, prevent lateral movement of caster plate 12 when caster plate 12 received within caster plate receiving void 25.

As best seen in FIG. 2, horizontal sidewalls 20b and 22b of guides 20 and 22, respectively, include spaced horizontal portions 27a and 27b, respectively, that define caster receiving gaps 29 therebetween. As hereinafter described, caster receiving gaps 29 allow for generally circular caster plate 12a to be positioned within caster plate receiving void 25 between vertical surfaces 23a and 23b of guides 20 and 22, respectively. Horizontal portions 27a and 27b of horizontal walls 20b and 22b include upwardly directed surfaces 31a and 31b, respectively, for slidably receiving caster plate 12 thereon. Upwardly directed surfaces 31a and 31b are vertically spaced from lower surface 28 of mounting bracket 10 to define guide tracks in guides 20 and 22 for caster plate 10, as well as, for supporting caster plate 12 when received with caster plate receiving void 25.

Resilient stops 24 and 26 project from lower surface 28 of mounting bracket 10. Stops 24 and 26 are longitudinally spaced a predetermined distance so as to receive caster plate 12 therebetween, FIG. 5. Resilient stops 24 and 26 include first ends integral with mounting plate 10 and opposite free ends 24a and 26a, respectively. The free ends 24a and 26a of stops 24 and 26, respectively, are movable between a retaining position wherein the free ends 24a and 26a of stops 24 and 26 project into caster plate receiving void 25 and a retracted position wherein the free ends 24a and 26a of stops 24 and 26 are generally co-planer with mounting bracket 10. It is contemplated that free ends 24a and 26a of stops 24 and 26, respectively, be biased toward the retaining position.

In operation, caster plate 12 is selectively positioned in the open ends of guides 20 and 22 on upper surfaces 31a of horizontal portions 27a of horizontal walls 20b and 22b or on upper surfaces 31b of horizontal portions 27b of horizontal walls 20b and 22b. By way of example, caster plate 12 is selectively positioned between guides 20 and 22 on upper surfaces 31a of horizontal portions 27a of horizontal walls 20b and 22b and slid over stop 24 so as to urge stop 24 towards lower surface 28 of mounting bracket 10 into the retracted position. Caster plate 12 continues to be longitudinally slid between guides 20 and 22 until the end of caster plate 12 engages stop 26. It can be appreciated that vertical surfaces 23a and 23b of vertical wall 20a and 22a, respectively, prevent lateral movement of caster plate 12 with cater plate 12 positioned in caster plate receiving void 25. Further, as caster plate 12 slides longitudinally past stop 24, stop 24 is urged outwardly away from lower surface 28 of mounting bracket 10, FIG. 5, to its retaining position such that the ends of caster plate 12 are captured between free ends 24a and 26a of stops 24 and 26, respectively.

Alternatively, caster plate 12 is selectively positioned between guides 20 and 22 on upper surfaces 31b of horizontal portions 27b of horizontal walls 20b and 22b and slid over stop 26 so as to urge stop 26 towards lower surface 28 of mounting bracket 10 into the retracted position. Caster plate 12 continues to be longitudinally slid between guides 20 and 22 until the end of caster plate 12 engages free end 24a of stop 24. It can be appreciated that vertical surfaces 23a and 23b of vertical wall 20a and 22a, respectively, prevent lateral movement of caster plate 12 when caster plate 12 is received within caster plate receiving void 25. Further, as caster plate 12 slides longitudinally past stop 26, stop 26 is urged outwardly away from lower surface 28 of mounting bracket 10, FIG. 5, to its retaining position such that the ends of caster plate 12 are captured between free ends 24a and 26a of stops 24 and 26, respectively.

In order to mount circular caster plate 12a to object 16, caster plate 12a is selectively positioned in the open ends of guides 20 and 22 such that caster plate 12a is received on upper surfaces 31a of horizontal portions 27a of horizontal walls 20b and 22b or on upper surfaces 31b of horizontal portions 27b of horizontal walls 20b and 22b. By way of example, caster plate 12a is selectively positioned between guides 20 and 22 on upper surfaces 31a of horizontal portions 27a of horizontal walls 20b and 22b. As caster plate 12a is slid into caster plate receiving void 25 and over stop 24, vertical walls 20a and 22a are urged outwardly so as to accommodate caster plate 12a therebetween. In addition, caster plate 12a urges stop 24 towards lower surface 28 of mounting bracket 10 into the retracted position. Caster plate 12 continues to be longitudinally slid between guides 20 and 22 until radially outer portions of caster plate 12a become seated in caster receiving gaps 29 between horizontal portions 27a and 27b in horizontal walls 20b and 22b. With radially outer portions of caster plate 12a seated in caster receiving gaps 29 between horizontal portions 27a and 27b in horizontal walls 20b and 22b, vertical walls 20b and 22b of guides 20 and 22, respectively, return to their original position, thereby capturing caster plate 12a within caster receiving gaps 29 and preventing longitudinal or lateral movement of caster plate 12. It is noted that as caster plate 12a slides longitudinally past stop 24, stop 24 is urged outwardly away from lower surface 28 of mounting bracket 10, FIG. 5, to its retaining position. As such, if caster plate 12a is inadvertently freed from caster receiving gaps 29, caster plate 12a is maintained within caster plate receiving void 25 by free ends 24a and 26a of stops 24 and 26, respectively.

Alternatively, caster plate 12a may be selectively positioned between guides 20 and 22 on upper surfaces 31b of horizontal portions 27b of horizontal walls 20b and 22b. As caster plate 12a is slid into caster plate receiving void 25 and over stop 26, vertical walls 20a and 22a of guides 20 and 22, respectively, are urged outwardly so as to accommodate caster plate 12a therebetween. In addition, caster plate 12a urges stop 26 towards lower surface 28 of mounting bracket 10 into the retracted position. Caster plate 12a continues to be longitudinally slid between guides 20 and 22 until radially outer portions of caster plate 12a become seated in caster receiving gaps 29 between horizontal portions 27a and 27b of horizontal walls 20b and 22b. With radially outer portions of caster plate 12a seated in caster receiving gaps 29 between horizontal portions 27a and 27b in horizontal walls 20b and 22b, vertical walls 20b and 22b of guides 20 and 22, respectively, return to their original position, thereby capturing caster plate 12a within caster receiving gaps 29 and preventing longitudinal or lateral movement of caster plate 12. It is noted that as caster plate 12a slides longitudinally past stop 26, stop 26 is urged outwardly away from lower surface 28 of mounting bracket 10, FIG. 5, to its retaining position. As such, if caster plate 12a is inadvertently freed from caster receiving gaps 29, caster plate 12a is maintained within caster plate receiving void 25 by free ends 24a and 26a of stops 24 and 26, respectively.

Referring to FIGS. 6-7, stops 24 and 22 may be replaced by longitudinally spaced, forward and rearward projections 30 and 32, respectively, depending from lower surface 28 of mounting bracket 10 into the guide tracks of guides 20 and 22. In operation, caster plate 12 is selectively positioned in the open ends of guides 20 and 22 on upper surfaces 31a of horizontal portions 27a of horizontal walls 20b and 22b or on upper surfaces 31b of horizontal portions 27b of horizontal walls 20b and 22b. By way of example, caster plate 12 is selectively positioned between guides 20 and 22 on upper surfaces 31a of horizontal portions 27a of horizontal walls 20b and 22b and slid over forward projections 30 in the guide tracks of guides 20 and 22 so as to urge horizontal walls 20a and 22a of guides 20 and 22, respectively, away from lower surface 28 of mounting bracket 10. Caster plate 12 continues to be longitudinally slid between guides 20 and 22 until the end of caster plate 10 engages rearward projections 32. As the opposite end of caster plate 12 slides longitudinally past forward projections 30, horizontal walls 20a and 22a of guides 20 and 22, respectively, return to their original position such that the ends of caster plate 12 are captured between forward and rearward projections 30 and 32, respectively, in guides 20 and 22, FIG. 7.

Similarly, caster plate 12 may be selectively positioned between guides 20 and 22 on upper surfaces 31b of horizontal portions 27b of horizontal walls 20b and 22b and slid over rearward projections 32 in the guide tracks of guides 20 and 22 so as to urge horizontal walls 20a and 22a of guides 20 and 22, respectively, away from lower surface 28 of mounting bracket 10. Caster plate 12 continues to be longitudinally slid between guides 20 and 22 until the end of caster plate 12 engages forward projections 30. As the opposite end of caster plate 12 slides longitudinally past rearward projections 32, horizontal walls 20a and 22a of guides 20 and 22, respectively, return to their original position such that the ends of caster plate 12 are captured between forward and rearward projections 30 and 32, respectively, in the guide tracks of guides 20 and 22, FIG. 7.

In order to mount caster plate 12a to object 16, caster plate 12a may be selectively positioned in the open ends at guides 20 and 22 on upper surfaces 31a of horizontal portions 27a of horizontal walls 20b and 22b or on upper surfaces 31b of horizontal portions 27b of horizontal walls 20b and 22b. By way of example, caster plate 12a is selectively positioned between guides 20 and 22 on upper surfaces 31a of horizontal portions 27a of horizontal walls 20b and 22b and slid over forward projections 30 in the guide tracks of guides 20 and 22 so as to urge horizontal walls 20b and 22b of guides 20 and 22, respectively, away from lower surface 28 of mounting bracket 10 and to urge vertical walls 20a and 22a of guides 20 and 22, respectively, away from each other. Caster plate 12a continues to be longitudinally slid between guides 20 and 22 until radially outer portions of caster plate 12a become seated in caster receiving gaps 29 between horizontal portions 27a and 27b in horizontal walls 20b and 22b. With radially outer portions of caster plate 12a seated in caster receiving gaps 29 between horizontal portions 27a and 27b in horizontal walls 20b and 22b, vertical walls 20b and 22b of guides 20 and 22, respectively, return to their original position, thereby capturing caster plate 12a within caster receiving gaps 29 and preventing longitudinal or lateral movement of caster plate 12. In addition, as caster plate 12a slides longitudinally past forward projections 30, horizontal walls 20a and 22a of guides 20 and 22, respectively, return to their original position. As a result, if caster plate 12a is inadvertently freed from caster receiving gaps 29, caster plate 12a is maintained within caster plate receiving void 25 by forward and rearward projections 30 and 32, respectively.

Similarly, caster plate 12a may be selectively positioned between guides 20 and 22 on upper surfaces 31b of horizontal portions 27b of horizontal walls 20b and 22b and slid over forward projections 30 in the guide tracks of guides 20 and 22 so as to urge horizontal walls 20b and 22b of guides 20 and 22, respectively, away from lower surface 28 of mounting bracket 10 and to urge vertical walls 20a and 22a of guides 20 and 22, respectively, away from each other. Caster plate 12a continues to be longitudinally slid between guides 20 and 22 until radially outer portions of caster plate 12a become seated in caster receiving gaps 29 between horizontal portions 27a and 27b in horizontal walls 20b and 22b. With radially outer portions of caster plate 12a seated in caster receiving gaps 29 between horizontal portions 27a and 27b in horizontal walls 20b and 22b, vertical walls 20b and 22b of guides 20 and 22, respectively, return to their original position, thereby capturing caster plate 12a within caster receiving gaps 29 and preventing longitudinal or lateral movement of caster plate 12a. In addition, as caster plate 12a slides longitudinally past rearward projections 32, horizontal walls 20a and 22a of guides 20 and 22, respectively, return to their original position. As a result, if caster plate 12a is inadvertently freed from caster receiving gaps 29, caster plate 12a is maintained within caster plate receiving void 25 by forward and rearward projections 30 and 32, respectively.

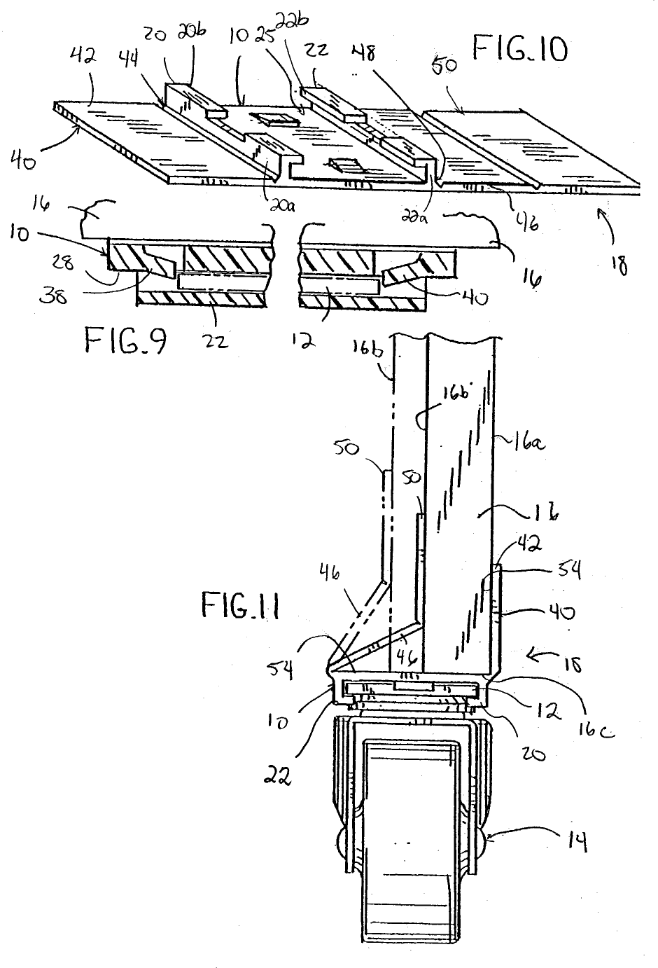

Referring to FIG. 8, forward and rearward projections 30 and 32, respectively, in guides 20 and 22, may be replaced by forward resilient stops 34 in a first end of guides 20 and 22 and by crimping the opposite ends 36 of guides 20 and 22 to prevent caster plate 12 from sliding therepast. Alternatively, forward and rearward projections 30 and 32, respectively, may be replaced by forward and rearward resilient stops 38 and 40 extending from lower surface 28 of mounting bracket 10 into guides 20 and 22, respectively, FIG. 9. Forward and rearward resilient stops 38 and 40, respectively, function in the same manner as stops 24 and 26, heretofore described. As such, the description heretofore of the functionality of stops 24 and 26 is understood to describe the function of forward and rearward resilient stops 38 and 40, respectively, as if fully described herein.

Referring to FIGS. 10-11, it is intended the various embodiments of mounting bracket 10 heretofore described may be incorporated into mounting assembly 18. Mounting assembly 18 includes a mounting plate 40 formed from a flexible material. Mounting plate 40 includes a first side portion 42 pivotally connected to first side 44 of mounting bracket 10 and a bracing portion 46 pivotally connected to second side 48 of mounting bracket 10. A second side portion 50 is pivotally connected to bracing portion. It is contemplated that upper surface 54 of mounting plate 40 have a layer of adhesive applied thereto. As such, mounting assembly 18 is designed to be adhesively secured to object 16. It is intended that first side portion 42 of mounting plate 40 be affixed to a first side 16a of object 16 and second side portion 50 of mounting plate 40 be affixed to a second side 16b of object 16. Upper surface 54 of mounting bracket 10 is affixed to bottom surface 16c of object 16. Bracing portion 46 extends between second side portion 50 of mounting plate 40 and mounting bracket 10 so as to allow mounting assembly 18 to be affixed to objects of different widths, FIG. 11. In addition, bracing portion 46 of mounting plate 40 provides support for mounting plate 40 during lateral movement of caster assembly 14.

Various modes of carrying out the invention are contemplated as being within the scope of the following claims particularly pointing out and distinctly claiming the subject matter that is regarded as the invention.

We claim:

1. A bracket for interconnecting a caster plate of a wheeled caster to a bottom surface of an object, the bracket comprising:
a generally flat mounting plate extending along an axis and having upper and lower surfaces, first and second sides and first and second ends;
first and second parallel guide tracks extending projecting from the lower surface of the mounting plate, each guide track having an upper surface for receiving the caster plate thereon, and first and second open ends; and
first and second plate retaining elements projecting from the lower surface of the mounting plate for retaining the caster plate on the upper surfaces of the guide tracks and prevent axial movement of the caster plate.

2. The bracket of claim 1 wherein first ends of the first and second guide tracks define an opening therebetween for allowing the caster plate to be slidably positioned on the upper surfaces of the first and second guide tracks.

3. The bracket of claim 2 wherein second ends of the first and second guide tracks define a second opening therebetween for allowing the caster plate to be slidably positioned on the upper surfaces of the first and second guide tracks.

4. The bracket of claim 1 wherein upper surfaces of the first and second guide tracks include first and second portions axially spaced portions defining caster receiving gaps therebetween.

5. The bracket of claim 1 wherein the first retaining element includes a first resilient tab projecting from the lower surface of the mounting plate.

6. The bracket of claim 1 wherein the second retaining element includes a second resilient tab projecting from the lower surface of the mounting plate at a location axially spaced from the first resilient tab.

7. The bracket of claim 1 wherein the first retaining element includes a generally rigid projection projecting from the lower surface of the mounting plate.

8. The bracket of claim 7 wherein the second retaining element includes a generally rigid projection projecting from the lower surface of the mounting plate at a location axially spaced from the generally rigid projection of the first retaining element.

9. The bracket of claim 1 wherein the first and second guide tracks include generally vertical sidewalls for interconnecting the upper surfaces of the guide tracks and the lower surface of the mounting plate.

10. The bracket of claim 1 further comprising a mounting structure for operatively connecting the mounting plate to the furniture object.

11. A bracket for interconnecting a caster plate of a wheeled caster to a bottom surface of an object, the bracket comprising:
a mounting plate extending along an axis and having upper and lower surfaces, first and second sides and first and second ends;
a first guide track extending along the lower surface of the mounting plate adjacent the first side of the mounting plate, the first guide track having an upper surface for receiving the caster plate thereon, and first and second open ends; and
a second guide track extending along the lower surface of the mounting plate adjacent the second side of the mounting plate, the second guide track having an upper surface for receiving the caster plate thereon, and first and second open ends; wherein the caster plate may be slidably positioned on the upper surfaces of the first and second guide tracks from one of the first ends of the first and second guide tracks and the second ends of the first and second guide tracks.

12. The bracket of claim 11 wherein first ends of the first and second guide tracks define an opening therebetween for allowing the caster plate to be slidably positioned on the upper surfaces of the first and second guide tracks.

13. The bracket of claim 12 wherein second ends of the first and second guide tracks define a second opening therebetween for allowing the caster plate to be slidably positioned on the upper surfaces of the first and second guide tracks.

14. The bracket of claim 11 wherein upper surfaces of the first and second guide tracks include first and second portions axially spaced portions defining caster receiving gaps therebetween.

15. The bracket of claim 11 further comprising a first resilient tab projecting from the lower surface of the mounting plate.

16. The bracket of claim 15 further comprising a second resilient tab projecting from the lower surface of the mounting plate at a location axially spaced from the first resilient tab.

17. The bracket of claim 11 further comprising a first, generally rigid projection projecting from the lower surface of the mounting plate.

18. The bracket of claim 17 further comprising a second, generally rigid projection projecting from the lower surface of the mounting plate at a location axially spaced from the first, generally rigid projection.

19. The bracket of claim 11 wherein the first and second guide tracks include generally vertical sidewalls for interconnecting the upper surfaces of the guide tracks and the lower surface of the mounting plate.

20. The bracket of claim 11 further comprising a mounting structure for operatively connecting the mounting plate to the furniture object.

21. A bracket for interconnecting a caster plate of a wheeled caster to a bottom surface of an object, the bracket comprising:
a mounting plate extending along an axis and having upper and lower surfaces, first and second sides and first and second ends;
a first guide track extending along the lower surface of the mounting plate adjacent the first side of the mounting plate, the first guide track having first and second axially spaced support surfaces for supporting the caster plate thereon; and
a second guide track extending along the lower surface of the mounting plate adjacent the second side of the mounting plate, the second guide track having first and second axially spaced support surfaces for supporting the caster plate thereon.

22. The bracket of claim 21 wherein the first guide track has first and second open ends and the second guide track has first and second open ends.

23. The bracket of claim 22 wherein first ends of the first and second guide tracks define an opening therebetween for allowing the caster plate to be slidably positioned on the supporting surfaces of the first and second guide tracks and wherein the second ends of the first and second guide tracks define a second opening therebetween for allowing the caster plate to be slidably positioned on the supporting surfaces of the first and second guide tracks.

24. The bracket of claim 21 further comprising a first resilient tab projecting from the lower surface of the mounting plate.

25. The bracket of claim 24 further comprising a second resilient tab projecting from the lower surface of the mounting plate at a location axially spaced from the first resilient tab.

26. The bracket of claim 21 further comprising a first, generally rigid projection projecting from the lower surface of the mounting plate.

27. The bracket of claim 26 further comprising a second, generally rigid projection projecting from the lower surface of the mounting plate at a location axially spaced from the first, generally rigid projection.

28. The bracket of claim 21 wherein the first and second guide tracks include generally vertical sidewalls for interconnecting the upper surfaces of the guide tracks and the lower surface of the mounting plate.

29. The bracket of claim 21 further comprising a mounting structure for operatively connecting the mounting plate to the furniture object.
